(19) United States
(12) Patent Application Publication
(10) Pub. No.: US 2021/0243433 A1
(43) Pub. Date: Aug. 5, 2021

(54) VIDEO CODING DEVICE, VIDEO CODING METHOD, AND VIDEO DECODING DEVICE

(71) Applicant: FUJITSU LIMITED, Kawasaki-shi (JP)

(72) Inventor: Kimihiko KAZUI, Kawasaki (JP)

(73) Assignee: FUJITSU LIMITED, Kawasaki-shi (JP)

(21) Appl. No.: 17/237,093

(22) Filed: Apr. 22, 2021

Related U.S. Application Data
(63) Continuation of application No. PCT/JP2019/032585, filed on Aug. 21, 2019.

(30) Foreign Application Priority Data
Dec. 28, 2018 (JP) 2018-247370

(51) Int. Cl. H04N 19/105; H04N 19/119; H04N 19/176; H04N 19/167

(52) U.S. Cl. CPC H04N 19/105; H04N 19/167; H04N 19/176; H04N 19/119

(57) ABSTRACT

A video coding device divides a coding target image contained in a video into regions to generate region information; generate reference constraint information that asymmetrically defines a reference constraint when information on a block in a second region is referred to from a block in a first region at one of boundaries between the first region and the second region, and a reference constraint when information on the block in the first region is referred to from the block in the second region at the one of boundaries; generates a determination result indicating whether to refer to information on an adjacent block adjacent to a coding target block, based on a positional relationship between the coding target block and the adjacent block, and the reference constraint information; codes the coding target block using the determination result; and codes the region information, the reference constraint information, and one of coding results.

### CROSS-REFERENCE TO RELATED APPLICATION

This application is a continuation application of International Application PCT/JP2019/032585 filed on Aug. 21, 2019 and designated the U.S., the entire contents of which are incorporated herein by reference. The International Application PCT/JP2019/032585 is based upon and claims the benefit of priority of the prior Japanese Patent Application No. 2018-247370, filed on Dec. 28, 2018, the entire contents of which are incorporated herein by reference.

### FIELD

The embodiments discussed herein are related to a video coding device, a video coding method, a video coding program, a video decoding device, a video decoding method, and a video decoding program.

### BACKGROUND

High efficiency video coding (H.265/HEVC) is known as an international standard relating to compression coding of video data. In the following, HEVC is sometimes used to indicate H.265/HEVC.

Related art is disclosed in Japanese Laid-open Patent Publication No. 2013-098734, “High Efficiency Video Coding” Recommendation ITU-T H.265, February 2018, “Vesafle Video Coding (Drat3)” JVET-L1001, October 2018 and “AHG12: Flexible Tile Splitting” JVET-L0359, October 2018.

### SUMMARY

According to an aspect of the embodiments, a video coding device includes: a memory; and a processor coupled to the memory and configured to: divide a coding target image contained in a video into a plurality of regions to generate region information that indicates the plurality of regions; generate reference constraint information that asymmetrically defines a reference constraint when information on a block in a second region is referred to from a block in a first region at one of boundaries between the first region and the second region among the plurality of regions, and a reference constraint when information on the block in the first region is referred to from the block in the second region at the one of boundaries; generate a determination result that indicates whether to refer to information on an adjacent block adjacent to a coding target block, based on a positional relationship between the coding target block and the adjacent block, and the reference constraint information; code the coding target block in accordance with the determination result; and code the region information, the reference constraint information, and one of coding results for the coding target block.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating picture division by tiles.

FIG. 2 is a diagram illustrating a decoding process by a vertical directional intra-refresh line scheme.

FIG. 3 is a diagram illustrating a picture in which a slice boundary is set.

FIG. 4 is a diagram illustrating a picture in which a tile boundary is set.

FIG. 5 is a configuration diagram of a video coding device.

FIGS. 6A and 6B are a diagram illustrating first picture division.

FIG. 7 is a diagram illustrating a reference constraint in the first picture division.

FIG. 8 is a diagram illustrating a bitstream.

FIG. 9 is a flowchart of a video coding process.

FIG. 10 is a configuration diagram of a video decoding device.

FIG. 11 is a flowchart of a video decoding process.

FIGS. 12A and 12B are a diagram illustrating second picture division.

FIG. 13 is a diagram illustrating a reference constraint in the second picture division.

FIG. 14 is a configuration diagram of an information processing device.

### DESCRIPTION OF EMBODIMENTS

Furthermore, at present, standardization work for versatile video coding (WC), which is the next international standard, is underway. In these standards, each picture contained in a video is divided into a plurality of units of processing.

The unit of division in the HEVC standard is coding tree unit (CTU). The CTU includes a luminance block made up of luminance components (Y) of horizontal M pixels and vertical M pixels, and a chrominance block made up of two kinds of chrominance components (Cb and Cr) at the same position. M is mainly given as a power-of-two value, such as 64 or 32. Note that, when a CTU is adjacent to the picture boundary, the number of effective vertical pixels or horizontal pixels is smaller than M in some cases.

The HEVC standard defines higher-level unit of division called a slice or a tile. In particular, the tile is a unit of division newly introduced in the HEVC standard, and corresponds to a rectangular region containing horizontal X (X>2) and vertical Y (Y>2) CTUs, which has not been achieved by the slice.

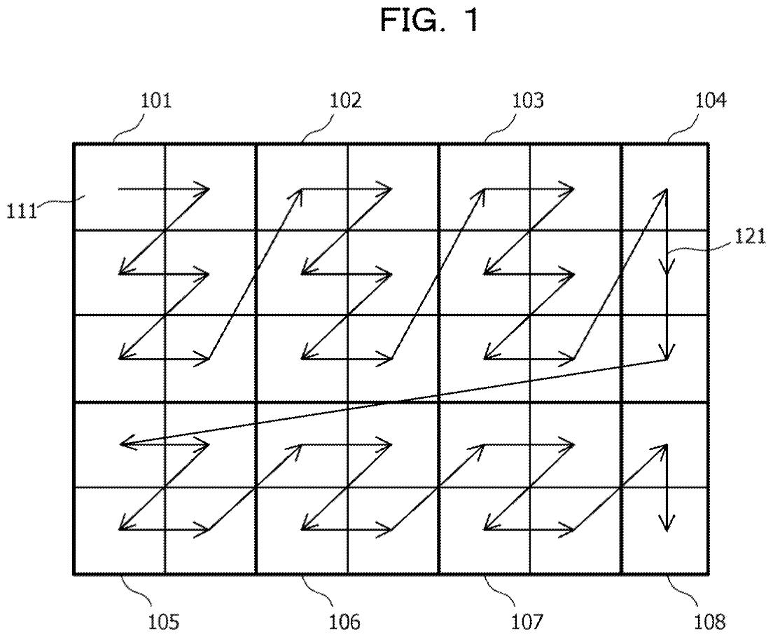

FIG. 1 illustrates an example of picture division by tiles. The picture in FIG. 1 is divided into four horizontally and two vertically, and is divided into tiles 101 to 108. For example, the tile 101 contains six CTUs 111.

The height and width of each tile can be freely set, but all tiles located at the same vertical position (for example, the tiles 101 to 104) have the same height, and all tiles located at the same horizontal position (for example, the tiles 101 and 105) have the same width.

In the picture in FIG. 1, each CTU is processed in accordance with a processing order 121. A plurality of tiles contained in a picture is processed in a raster scan order (from the upper left to the lower right), and a plurality of CTUs contained in each tile is also processed in the raster scan order.

The process for each tile can be performed independently for each tile. Specifically, in entropy coding, a delimiter is inserted by the termination of the final CTU in the tile. Furthermore, in intra-prediction or motion vector prediction for a coding unit (CU) in a tile, it is prohibited to refer to information on a CU located outside the tile. Tile division is useful when a plurality of rectangular regions in a picture is processed in parallel, for example.

Many video coding standards such as HEVC define a hypothetical reference decoder (HRD) model, which indicates the decoding timing of the coded picture and the output (display) timing of the decoded picture. The HRD model constrains the bitstream in terms of decoding timing and output timing.

In standards prior to the HEVC standard, the decoding timing of the coded picture is defined only in units of coded pictures. In the HEVC standard, the decoding timing for each small region in the picture can be defined in addition to the coded picture. In the HEVC standard, the coded picture is called an access unit (AU), and the small region in the picture is called a decoding unit (DU).

The DU contains a plurality of slices. By defining the decoding timing in units of DUs, a video decoding device is allowed to start decoding each DU before the entire coded picture is transmitted to the video decoding device. Therefore, the completion of the decoding of the entire coded picture can be advanced earlier, and as a result, the output timing of the decoded picture can be brought forward. The HRD model of the HEVC standard is useful for ultra-low-delay coding described below.

The ultra-low-delay coding is a coding control that suppresses a transmission delay, which is from the input of each picture to the video coding device until the video decoding device outputs a decoded picture corresponding to the input picture, to less than one picture time.

The transmission delay is obtained by the sum of a delay proportional to the capacity of a coded picture buffer of the video decoding device and a delay proportional to the number of reordering picture banks of a decoded picture buffer of the video decoding device. According to the definition of the HRD model, the coded picture buffer is called a CPB, and the decoded picture buffer is called a DPB.

In the CPB, a buffer capacity equivalent to the maximum amount of data in the unit of decoding (AU or DU) is secured so as not to cause buffer overflow. In the DPB, a sufficient number of decoded picture banks are secured for a picture reordering process performed at the time of bidirectional inter-frame prediction.

By adopting an order that does not require the picture reordering process (which is an order in which the video coding device codes respective pictures in the order of input) as the picture coding order, and adopting the average amount of data in the unit of decoding as the size of the CPB, the transmission delay is minimized. In particular, by adopting the DU as the unit of decoding, the transmission delay may become an ultra-low delay of less than one picture time.

A vertical directional intra-refresh line scheme is known as a method of regulating the CPB size to the average amount of DU data while maintaining the bit rate low. In the intra-refresh, a refresh operation is performed such that a complete decoded picture can be output even when the video decoding device starts decoding the bitstream from the middle of the bit stream. In the vertical directional intra-refresh line scheme, intra-coded blocks for the refresh operation are evenly distributed to all pictures and all CTU lines.

Here, “complete decoding” means decoding in which exactly the same decoding result as when decoding is started from the beginning of the bitstream can be obtained. The vertical directional intra-refresh line scheme achieves a CPB with a data capacity of less than one picture time, which has been difficult in a refresh operation using an ordinary intra-coded picture.

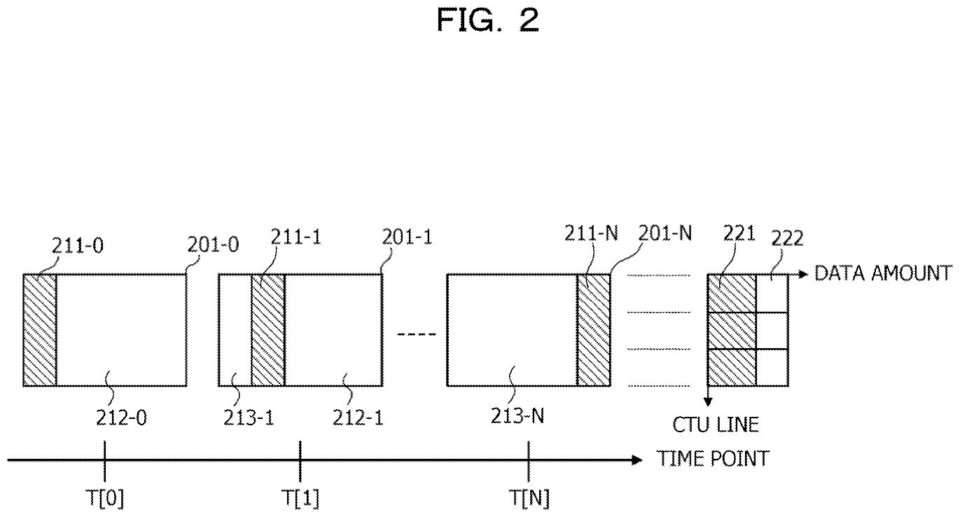

FIG. 2 illustrates an example of a decoding process by the vertical directional intra-refresh line scheme. At a time point T[i] (i=0 to N) (N is an integer equal to or greater than one), the coded data of pictures 201-i is input to the video decoding device. Each picture 201-i contains an intra-coded region 211-i (i=0 to N), an inter-coded region 212-i (I=0 to N−1), and an inter-coded regions 213-i(i=1 to N).

In the refresh operation in a cycle (N+1), the video decoding device starts decoding at a time point T[0] and completes normal decoding of all pictures at a time point T[N]. In order to achieve this refresh operation, the position of the intra-coded region 211-i in the picture shifts from the left to the right for each picture, and by the time point T[N], a region corresponding to one picture is covered by the regions 211-0 to 211-N.

By using a vertically long rectangle as the shape of the region 211-i and moving the region 211-i from the left end to the right end of the picture from the time point T[0] to the time point T[N], the same number of intra-coded blocks can always be inserted into all pictures and all CTU lines.

A data amount 221 represents an ideal amount of data of the intra-coded block contained in each CTU line of each picture, and a data amount 222 represents an ideal amount of data of the inter-coded block contained in each CTU line of each picture. By maintaining the number of intra-coded blocks in the CTU line constant, control that makes the amount of data in each CTU line ideal (uniform) while suppressing fluctuations in image quality for each block even under low bit rate conditions can be easily achieved.

A technique that improves the coding efficiency in the picture division coding scheme is known in relation to the compression coding of video data. A flexible tile division method is also known.

When ultra-low-delay coding using the vertical directional intra-refresh line scheme is achieved under the existing video coding standard, a disadvantage of lowered coding efficiency occurs.

Note that such a disadvantage arises not only in video coding using the vertical directional intra-refresh line scheme, but also in other video coding in which a coding target image is divided into a plurality of regions and coded.

In one aspect, the coding efficiency in video coding in which a coding target image is divided into a plurality of regions that contain blocks and coded may be improved.

Hereinafter, embodiments will be described in detail with reference to the drawings.

The HEVC standard defines that a DU contains a plurality of slices. The reason for this is to dearly specify the delimiter between DUs within the bitstream. In the entropy coding of the HEVC standard, context adaptive binary arithmetic coding (CABAC), which is arithmetic coding, is adopted.

The CABAC is capable of collectively coding a plurality of pieces of coding target data called bins into one bit. Therefore, it is difficult to define the delimiter between CTUs in the bitstream. In the HEVC standard, the CABAC is terminated at the boundary between slices or tiles. This allows the CABAC coding of each slice or each tile to be performed independently.

When one CTU line is adopted as one DU in order to reduce the transmission delay to a time period corresponding to one CTU line, a slice boundary or a tile boundary is inserted for each CTU line. Inserting the slice boundary or tile boundary for each CTU line prohibits reference to a pixel value and reference to a coding parameter across the boundary between the CTU lines, which lowers the efficiency of intra-prediction and an in-loop filter, and in turn lowers the overall coding efficiency.

Apart from this disadvantage, a disadvantage of lowered coding efficiency also arises in the coding process for guaranteeing the complete decoding of a picture within a refresh cycle.

In order to guarantee the complete decoding, it is desirable to perform coding such that the intra-coded region 211-i illustrated in FIG. 2 and the inter-coded region 213-i located on the left side of the region 211-i are always completely decoded. Therefore, when the decoded pixel value is referred to, it is preferable to provide a reference limitation that prohibits reference to the inter-coded region 212-i located on the right side of the region 211-i. The reason for this is that the complete decoding is not guaranteed for a block in the region 212-i.

A method that achieves the complete decoding while suppressing lowered coding efficiency may be provided. In this method, both of the video coding device and the video decoding device operate while limiting reference across a virtual reference boundary. For example, in the example in FIG. 2, the virtual reference boundary is set between the regions 211-i and 212-i.

However, existing video coding standards such as the HEVC standard do not define the virtual reference boundary. In order to achieve an equivalent reference limitation, it is desirable to set a slice boundary or a tile boundary at the position of the virtual reference boundary.

When the slice boundary is set at the position of the virtual reference boundary, two slices are inserted in one CTU line, which increases the number of CABAC terminations and lowers the coding efficiency. Furthermore, since reference across the boundary between CTU lines is prohibited in addition to the boundary between the regions 211-i and 212-i, the coding efficiency is lowered.

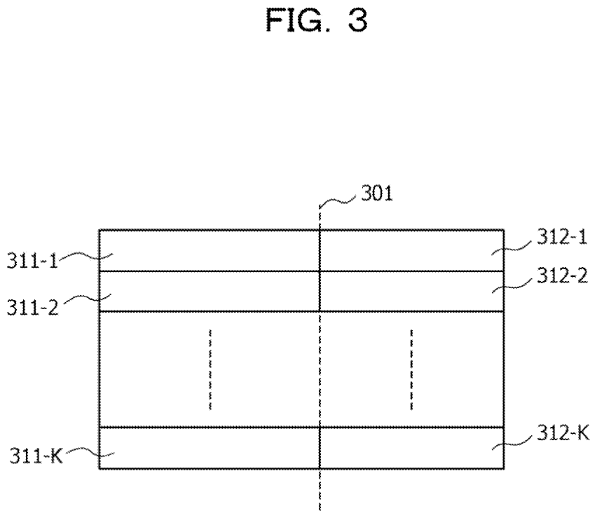

FIG. 3 illustrates an example of a picture in which a slice boundary is set at the position of the virtual reference boundary. The picture in FIG. 3 is set with a virtual reference boundary 301 and contains slices 311-1 to 311-K and slices 312-1 to 312-K (K is an integer equal to or greater than two). Two slices, namely, the slices 311-j and 312-j (j=1 to K), are inserted in one CTU line.

By inserting such slices, it is possible to prohibit reference between blocks located on the left and right of the reference boundary 301. However, for example, since it is also prohibited to refer to information on a block in the slice 311-1 upwardly adjacent to a block in the slice 311-2 from this block, the coding efficiency is lowered.

Meanwhile, when the tile boundary is set at the position of the virtual reference boundary, reference across the boundary between CTU lines is enabled. However, according to the tile definition of the HEVC standard, it is difficult to minimize the size of the CPB because the processing order of the CTUs is the raster scan order in the tile.

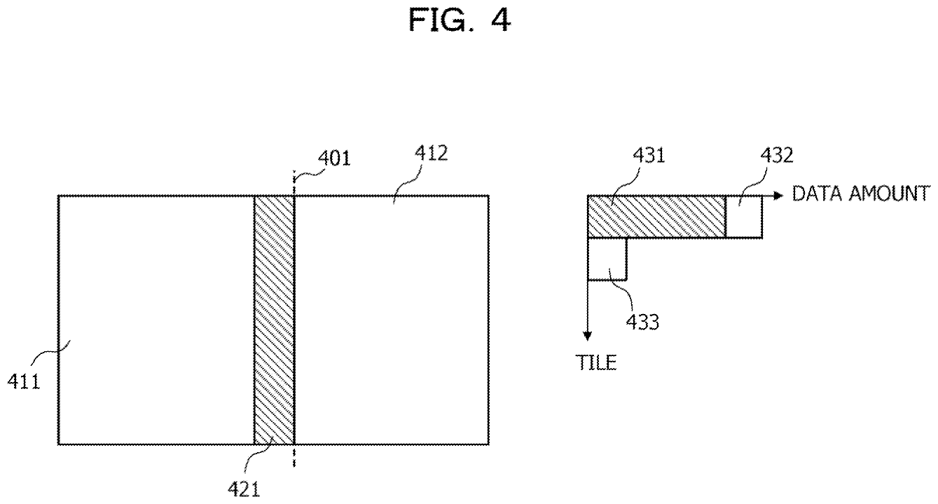

FIG. 4 illustrates an example of a picture in which a tile boundary is set at the position of the virtual reference boundary. The picture in FIG. 4 is set with a virtual reference boundary 401 and contains tiles 411 and 412. The tile 411 contains an intra-coded region 421.

A data amount 431 represents the amount of data of the intra-coded region 421 contained in the tile 411, and a data amount 432 represents the amount of data of an inter-coded region contained in the tile 411. A data amount 433 represents the amount of data of an inter-coded region contained in the tile 412. Since the tile 412 does not contain an intra-coded region, the data amount 433 is smaller than the sum of the data amounts 431 and 432, and as a result, variations in the data amount for each DU becomes large.

Such a disadvantage can be caused not only in the video coding according to the HEVC standard but also in the video coding according to the WC standard.

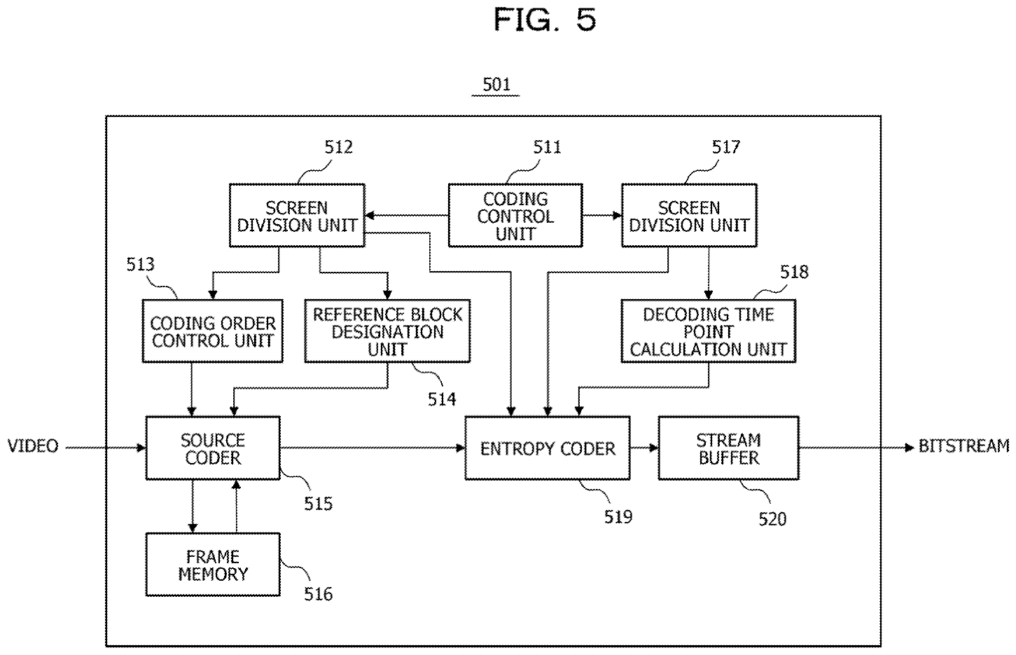

FIG. 5 illustrates a configuration example of a video coding device according to an embodiment. The video coding device 501 in FIG. 5 includes a coding control unit 511, a screen division unit 512, a coding order control unit 513, a reference block designation unit 514, a source coder 515, and a frame memory 516. The video coding device 501 further includes a screen division unit 517, a decoding time point calculation unit 518, an entropy coder 519, and a stream buffer 520.

The screen division unit 512 is an example of a division unit, the reference block designation unit 514 is an example of a determination unit, the source coder 515 is an example of a first coder, and the entropy coder 519 is an example of a second coder. The screen division unit 517 and the decoding time point calculation unit 518 are an example of a generation unit.

The video coding device 501 can be implemented as, for example, a hardware circuit. In this case, respective constituent elements of the video coding device 501 may be implemented as individual circuits or may be implemented as one integrated circuit.

The video coding device 501 codes a video that has been input by the vertical directional intra-refresh line scheme, and outputs a coded video as a bitstream. The video coding device 501 can transmit the bitstream to a video decoding device via a communication network.

For example, the video coding device 501 may be incorporated in a video camera, a video transmission device, a videophone system, a computer, or a mobile terminal device.

The video to be input contains a plurality of images one-to-one corresponding to a plurality of time points. The image at each time point is sometimes called a picture or frame. Each image may be a color image or a monochrome image. In the case of a color image, the pixel values may be in the RGB format or in the YUV format.

The coding control unit 511 designates the position of the virtual reference boundary in each image, a moving direction in which the reference boundary moves between the images, and the number of units of decoding in each image on the basis of coding parameters input from an external device. For example, the image size, bit rate, delay time, refresh cycle, and the like are input as coding parameters, and the decoding unit (DU) is used as the unit of decoding.

The screen division unit 512 designates the number and positions of rectangular regions in a coding target image contained in the input video on the basis of the position and the moving direction of the reference boundary designated by the coding control unit 511, and divides the coding target image into a plurality of rectangular regions. Then, the screen division unit 512 outputs region information that indicates the designated number and positions of the rectangular regions, to the coding order control unit 513, the reference block designation unit 514, and the entropy coder 519. For example, the tiles are used as the rectangular regions, and each rectangular region contains a plurality of blocks such as the CTUs and CUs.

Furthermore, the screen division unit 512 generates reference constraint information between the CTUs on the basis of the moving direction of the reference boundary, and outputs the generated reference constraint information to the reference block designation unit 514 and the entropy coder 519. The reference constraint information asymmetrically defines a reference constraint when information on a block in one rectangular region is referred to from a block in another rectangular region at a boundary between the rectangular regions, and a reference constraint when information on the block in the another rectangular region is referred to from the block in the one rectangular region at the boundary.

The coding order control unit 513 designates the total number of CTUs in the coding target image, the shape of each CTU, and a source coding order on the basis of the region information output by the screen division unit 512.

The reference block designation unit 514 designates the reference constraint for a coding target block in each CTU on the basis of the positional relationship between the blocks in the coding target image and the reference constraint information output by the screen division unit 512, and generates a determination result that indicates the designated reference constraint. The positional relationship between the blocks includes a positional relationship between the coding target block and an adjacent block adjacent to the coding target block, and the determination result indicates whether to permit reference to information on the adjacent block in a coding process for the coding target block.

The source coder 515 divides the coding target image into a plurality of CTUs, and codes each block in the CTU by source coding in the raster scan order in the CTU. The source coding includes intra-prediction or inter-prediction, orthogonal transformation and quantization of a prediction error, inverse quantization and inverse orthogonal transformation of a quantization result, addition of a restoration prediction error and a predicted value, and an in-loop filter. The quantization result is the result of quantizing an orthogonal transformation coefficient of the prediction error (quantization coefficient), and represents the coding result in the source coding.

The source coder 515 controls the processing order of the respective CTUs and the shape of each CTU in accordance with the source coding order designated by the coding order control unit 513, and also designates whether to refer to information on the adjacent block in accordance with the determination result of the reference block designation unit 514. Then, the source coder 515 outputs the coding parameters and the quantization result for each block to the entropy coder 519.

The frame memory 516 stores a locally decoded pixel value of the CTU generated by the source coder 515, and outputs the locally decoded pixel value to the source coder 515 when the source coder 515 codes the succeeding CTU. The output locally decoded pixel value is used to generate the predicted value of the succeeding CTU.

The screen division unit 517 designates the number of DUs in the coding target image and a CTU position at which a CABAC termination process is performed, on the basis of the delay time designated by the coding control unit 511. The CTU position at which the CABAC termination process is performed indicates a delimiter position different from the boundary between the rectangular regions in the coding results for a plurality of blocks contained in the coding target image. Then, the screen division unit 517 outputs DU information that indicates the designated number of DUs, to the decoding time point calculation unit 518 and the entropy coder 519, and outputs position information that indicates the designated CTU position, to the entropy coder 519.

The decoding time point calculation unit 518 designates a decoding time point at which the decoding of each DU is started, in accordance with the DU information output by the screen division unit 517, and outputs decoding time point information that indicates the designated decoding time point, to the entropy coder 519.

The entropy coder 519 codes the coding parameters and the quantization result for each block output by the source coder 515, by entropy coding using CABAC, and generates a bitstream. At this time, along with the coding parameters and the quantization result for each block, the region information and the reference constraint information output by the screen division unit 512, the DU information and the position information output by the screen division unit 517, and the decoding time point information output by the decoding time point calculation unit 518 are also coded.

The stream buffer 520 stores the bitstream containing the coding parameters and the quantization result for each block, the region information, the reference constraint information, the DU information, the position information, and the decoding time point information, and outputs the bitstream to the communication network.

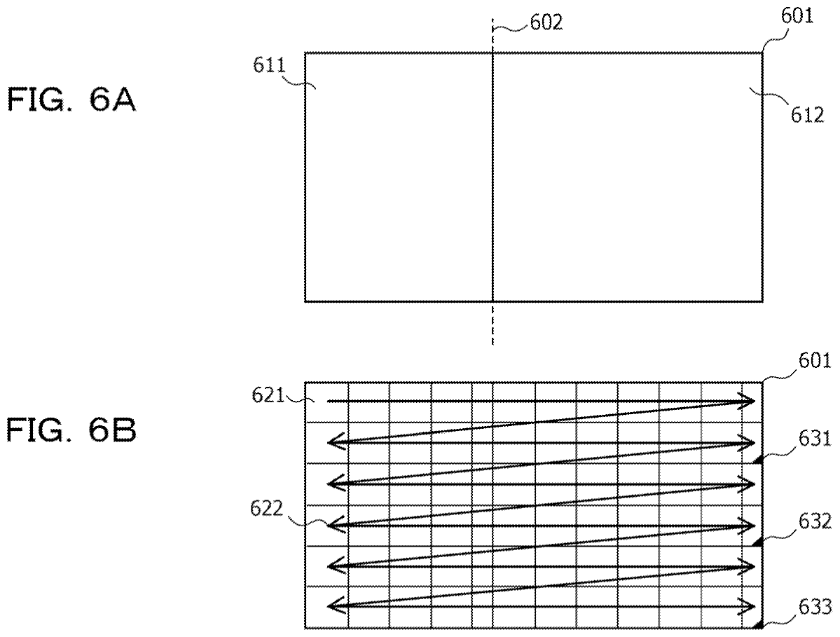

FIGS. 6A and 68 illustrate an example of first picture division when the tiles are used as the rectangular regions. FIG. 6A illustrates an example of tiles in a picture corresponding to the coding target image. A picture 601 is divided into tiles 611 and 612, and the boundary between the tiles 611 and 612 coincides with a virtual reference boundary 602. The reference boundary 602 extends in a perpendicular direction (vertical direction) in the picture 601.

FIG. 6B illustrates an example of CTUs in the picture 601. The picture 601 is divided into a plurality of CTUs 621. In this example, the position of the reference boundary 602 in a horizontal direction does not match a position at an integral multiple of the CTU width, and thus the shape of a CTU adjacent to the reference boundary 602 on the left side is rectangular rather than square.

A processing order 622 of the respective CTUs in the picture 601 is the raster scan order in the picture 601 independent of the shapes of the tiles 611 and 612. Note that the processing order of respective CUs in each CTU is the raster scan order in the CTU, as in the HEVC standard.

CTU positions 631 to 633 indicate boundaries between DUs when the picture 601 is divided into three DUs, and are set at positions immediately after the coding results for blocks in contact with a right end of the picture 601. In this case, the entropy coder 519 performs entropy coding in accordance with the CTU positions 631 to 633. Accordingly, the CABAC termination process is performed at each of the CTU positions 631 to 633.

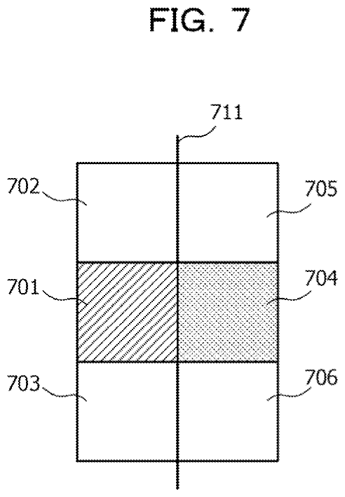

FIG. 7 illustrates an example of the reference constraint in the first picture division in FIGS. 6A and 6B. A boundary 711 between tiles corresponds to the reference boundary 602 in FIGS. 6A and 6B. CTUs 701 to 703 are adjacent to the boundary 711 on the left side, and CTUs 704 to 706 are adjacent to the boundary 711 on the right side.

The screen division unit 512 generates the reference constraint information between CTUs on the basis of the moving direction of the reference boundary 602. For example, when the reference boundary 602 moves from the left to the right, referring to information on a block in a CTU located on the right side of the boundary 711 from a block in a CTU located on the left side of the boundary 711 is limited.

For example, when the CTU 701 is to be processed, CUs in the CTU 701 are allowed to refer to only information on CUs in the CTUs 701 to 703 located on the left side of the boundary 711. Accordingly, it is prohibited to refer to information on CUs in the CTUs 704 to 706 located on the right side of the boundary 711.

On the other hand, when the CTU 704 is to be processed, CUs in the CTU 704 are also allowed to refer to information on CUs in the CTUs 701 to 703 in addition to information on CUs in the CTUs 704 to 706.

In this manner, at the boundary 711, a reference constraint when information on a block in the tile 612 on the right side is referred to from a block in the tile 611 on the left side, and a reference constraint when information on a block in the tile 611 is referred to from a block in the tile 612 are defined asymmetrically.

Note that, when intra-prediction is performed, a reference constraints according to the processing order is further applied as in the HEVC standard. For example, in intra-prediction, it is prohibited for a CU in the CTU 704 to refer to information on a CU in the CTU 703.

The picture division in FIGS. 6A and 6B and the reference constraint in FIG. 7 are applied to the video decoding device similarly to the video coding device 501.

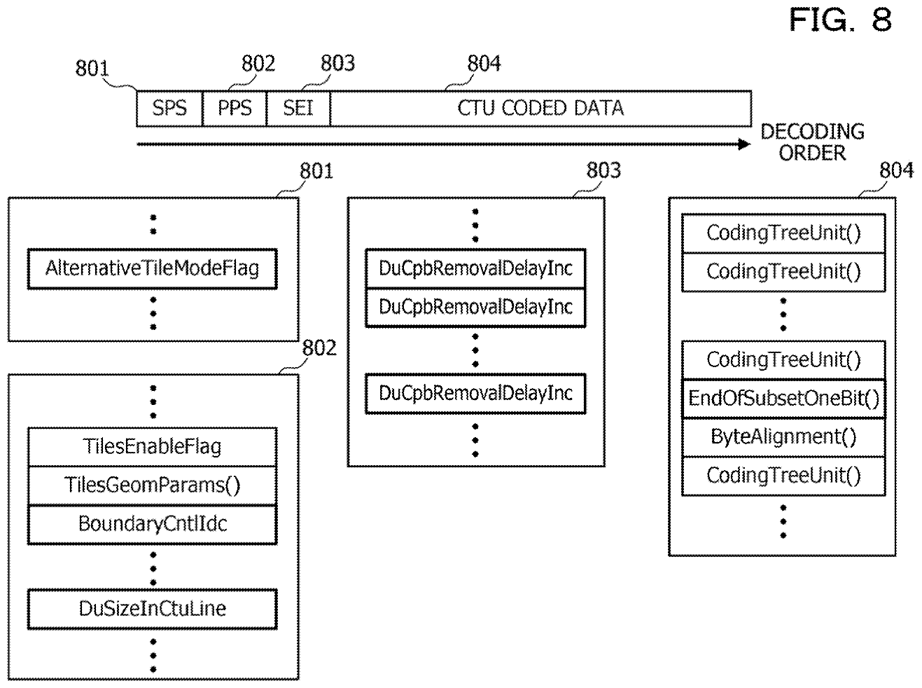

FIG. 8 illustrates an example of a bitstream output by the video coding device 501. The bitstream in FIG. 8 corresponds to one coded image and contains a sequence parameter set (SPS) 801, a picture parameter set (PPS) 802, supplemental enhancement Information (SEI) 803, and CTU coded data 804.

The SPS 801 corresponds to the SPS of the HEVC standard, and is attached for each of a plurality of coded images. The PPS 802 corresponds to the PPS of the HEVC standard. The SEI 803 is auxiliary data, and corresponds to the picture timing SEI of the HEVC standard. The CTU coded data 804 is the coding results for respective CTUs in the image, and corresponds to SliceSegmentData( ) of the HEVC standard.

The SPS 801 contains a flag AltemativeTileModeFlag that indicates that a CTU processing order and reference limitations different from those of tiles of the HEVC standard are to be used. When AltemativeTileModeFlag has 0, a CTU processing order and reference limitations similar to those of tiles of the HEVC standard are to be used. Other syntax of the SPS 801 is equivalent to the syntax of the SPS of the HEVC standard.

The PPS 802 contains TilesEnableFlag that indicates that the tiles are to be used. TilesEnableFlag is equivalent to that of the HEVC standard. When TilesEnableFlag has 1, the PPS 802 contains a set of parameters TilesGeomParams( ), which describes the number and positions of the tiles. TilesGeomParams( ) contains NumTileColumnsMinus1 and the like, and is equivalent to that of the HEVC standard.

When AltemativeTileModeFlag has 1, the PPS 802 further contains BoundaryCntlIdc, which describes the presence or absence of a reference limitation at the tile boundary and the direction of the limitation, and DuSizeInCtuLine, which indicates the size of the DU (the number of CTU lines). The number of DUs in the image is worked out by ceil(H/DuSizeInCtuLine). The parameter ceil( ) is a ceiling function (round-up function), and H represents the number of CTU lines contained in the image.

The SEI 803 contains decoding time point information DuCpbRemovalDelayInc on each DU except for the last DU in the image. The method of calculating the decoding time point of each DU from DuCpbRemovalDelayInc and the other syntax of the SEI 803 are equivalent to the case of the picture timing SEI of the HEVC standard.

The CTU coded data 804 contains CodingTreeUnit( ) corresponding to one CTU, EndOfSubsetOneBit, which means the termination of the CABAC, and an additional bit string ByteAlignment( ) for byte alignment. When AlternativeTileModeFlag has 0, EndOfSubsetOneBit is inserted at the tile boundary in the HEVC standard (at a location where TileId of CTUs becomes discontinuous). On the other hand, when AlternativeTileModeFlag has 1, EndOfSubsetOneBit is inserted immediately after CodingTreeUnit( ) corresponding to a CTU designated by DuSizeInCtuLine.

Next, the operations of the video coding device 501 and the video decoding device based on the parameters in the bitstream illustrated in FIG. 8 will be described. Since the operations when AlternativeTileModeFlag has 0 are similar to the operations in the HEVC standard, only the operations when AltemativeTileModeFlag has 1 will be described below.

An entropy decoding order of the CTUs is the raster scan order in the image. For example, when the number of CTUs contained in one CTU line is assumed as W, a CTU located at an X-th place from the left end of the image (X=0, 1, 2, . . . ) and a Y-th place from the top end of the image (Y=0, 1, 2, . . . ) has an (X+W*Y)-th place in the entropy decoding order.

When conforming to TilesGeomParams( ) of the HEVC standard, W is given by ceil(PicWidth/CtuWidth). PicWidth and CtuWidth denote the image width (the unit is a pixel) and the CTU width (the unit is a pixel) designated by the SPS parameter, respectively.

On the other hand, when conforming to TilesGeomParams( ) of Non-Patent Document 3, W is found by the result of summing the number of CTUs in the horizontal direction in each tile for all tiles located in the same vertical position. Here, the number of CTUs in the horizontal direction in the tile is given by ceil(TileWidth/CtuWidth). TileWidth denotes the tile width (the unit is a pixel) calculated from ColumnWidthMinus1.

The handling of TilesGeomParams( ) (the designation of the number of tiles, the size of each tile, and the position of each tile) is equivalent to the case of the HEVC standard or Non-Patent Document 3. For example, when NumTileColumnsMinus1 has 1, the number of tiles in the horizontal direction is given as two.

The operation is switched as follows depending on the value of BoundaryCntIdc.

In the case of BoundaryCntlIdc=0: referring to intra-prediction across tile boundaries is not permitted, but referring to pixels for the in-loop filter is allowed. This operation corresponds to a case where LoopFilterAcrossTilesEnabledFag of the HEVC standard has 1.

In the case of BoundaryCntlIdc=1: referring to intra-prediction across tile boundaries is not permitted, and referring to pixels for the in-loop filter is not permitted as well. This operation corresponds to a case where LoopFilterAcrossTilesEnabledFag of the HEVC standard has 0.

In the case of BoundaryCntIdc=2: a CU contained in a tile with a small TileId is not permitted to refer to information on a CU contained in a tile with a large TileId. This operation is adopted when there is an intra-coded region on the left side of the virtual reference boundary.

In the case of BoundaryCntIdc=3: a CU contained in a tile with a large TileId is not permitted to refer to information on a CU contained in a tile with a small TileId. This operation is adopted when there is an intra-coded region on the right side of the virtual reference boundary.

Note that information can always be referred to between CUs contained in the same tile.

The CTU position (entropy coding order) at which the CABAC termination process is performed is designated depending on the value of DuSizeInCtuLine. When the number of CTUs contained in one CTU line is assumed as W, the termination of the CABAC is inserted immediately before a (DuSizeInCtuLine*W)-th CTU for each of these CTUs.

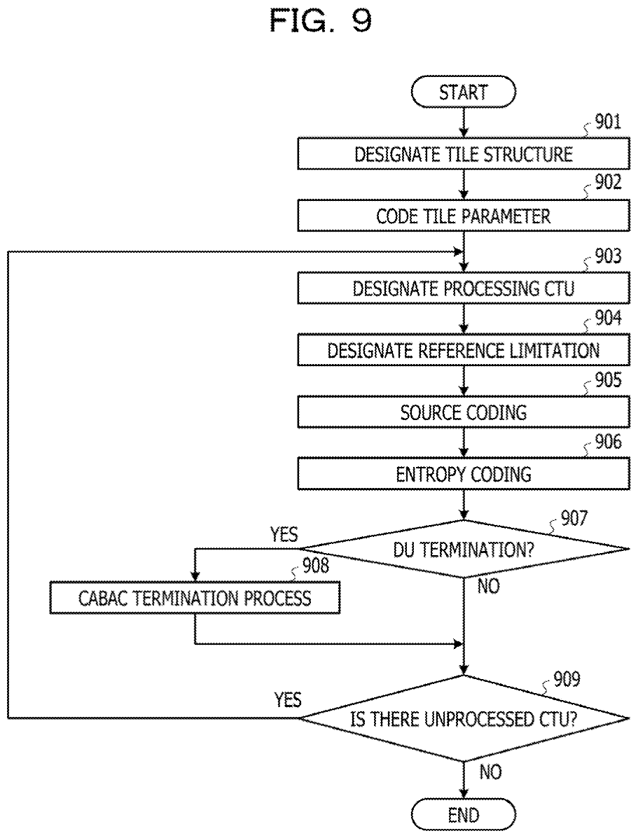

FIG. 9 is a flowchart illustrating an example of a video coding process performed by the video coding device 501. The video coding process in FIG. 9 is applied to each image contained in the video. In this video coding process, the tiles are used as the rectangular regions.

First, the video coding device 501 designates a tile structure of a coding target image (step 901), and codes a tile parameter in accordance with the designated tile structure (step 902).

Next, the video coding device 501 designates a CTU to be processed (a processing CTU) (step 903). At this time, the video coding device 501 designates the position and size of the processing CTU in the raster scan order in the image. Then, the video coding device 501 designates the reference limitation for an adjacent block on the basis of the position of the processing CTU and the position of the tile boundary (step 904).

Next, the video coding device 501 performs source coding on the processing CTU (step 905). In source coding, the video coding device 501 controls the amount of data by, for example, adjusting a quantization parameter such that a DU that contains the processing CTU reaches the CPB prior to the decoding time point of the DU in the video decoding device described by the picture timing SEI.

Next, the video coding device 501 performs entropy coding on the processing CTU (step 906), and checks whether the processing CTU corresponds to the termination of the DU (step 907).

When the processing CTU corresponds to the termination of the DU (step 907, YES), the video coding device 501 performs the CABAC termination process (step 908), and checks whether an unprocessed CTU remains in the coding target image (step 909). On the other hand, when the processing CTU does not correspond to the termination of the DU (step 907, NO), the video coding device 501 performs the process in step 909.

When an unprocessed CTU remains (step 909, YES), the video coding device 501 repeats the processes in step 903 and the subsequent steps. When no unprocessed CTU remains (step 909, NO), the video coding device 501 ends the process.

According to the video coding device 501 in FIG. 5, the coding efficiency can be improved in the video coding in which a coding target image is divided into a plurality of rectangular regions and coded. Accordingly, the amount of codes can be reduced while the image quality of the decoded image is maintained. In particular, in ultra-low-delay coding using the vertical directional intra-refresh line scheme, the coding efficiency can be improved.

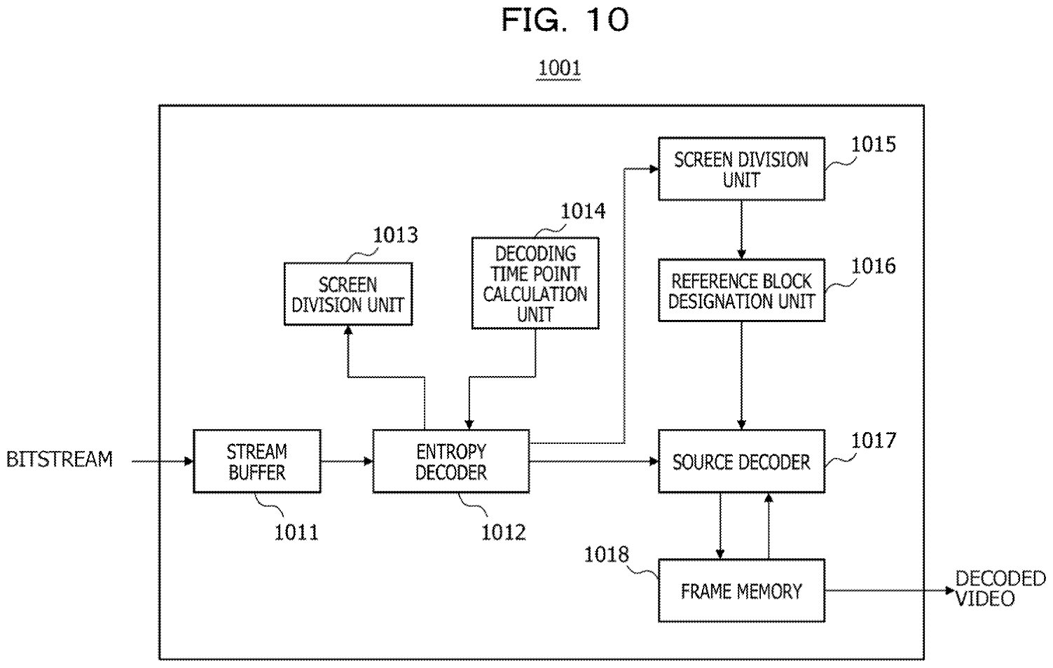

FIG. 10 illustrates a configuration example of a video decoding device that decodes a bitstream output from the video coding device 501. A video decoding device 1001 in FIG. 10 includes a stream buffer 1011, an entropy decoder 1012, a screen division unit 1013, a decoding time point calculation unit 1014, a screen division unit 1015, a reference block designation unit 1016, a source decoder 1017, and a frame memory 1018.

The entropy decoder 1012 is an example of a first decoder, and the source decoder 1017 is an example of a second decoder. The screen division unit 1015 is an example of a division unit, and the reference block designation unit 1016 is an example of a determination unit.

The video decoding device 1001 can be implemented as, for example, a hardware circuit. In this case, respective constituent elements of the video decoding device 1001 may be implemented as individual circuits or may be implemented as one integrated circuit.

The video decoding device 1001 decodes a bitstream of an input coded video and outputs a decoded video. The video decoding device 1001 can receive the bitstream from the video coding device 501 in FIG. 5 via a communication network.

For example, the video decoding device 1001 may be incorporated in a video camera, a video reception device, a videophone system, a computer, or a mobile terminal device.

The stream buffer 1011 stores the input bitstream, and when header information (SPS, PPS, and SEI) of each coded image arrives at the stream buffer 1011, notifies the entropy decoder 1012 of the arrival of the header information.

The entropy decoder 1012 performs entropy decoding on the bitstream. When notified of the arrival of the header information by the stream buffer 1011, the entropy decoder 1012 reads out the coded data of the header information from the stream buffer 1011, and decodes the read-out coded data by entropy decoding. With this process, the region information, the reference constraint information, the DU information, the position information, and the decoding time point information are restored. The entropy decoder 1012 outputs the DU information, the position information, and decoding time point information to the screen division unit 1013, and outputs the region information and the reference constraint information to the screen division unit 1015.

The entropy decoder 1012 reads out the coded data of a DU from the stream buffer 1011 when the decoding time point of the DU notified from the decoding time point calculation unit 1014 comes, and performs the entropy decoding on each CTU in the DU in the order of data. With this process, the coding result for each block is restored as a decoding target code of the coded block. The entropy decoder 1012 outputs the decoding target code of the coded block to the source decoder 1017.

The screen division unit 1013 calculates the CTU position of the final CTU in each DU on the basis of the DU information and the position information output by the entropy decoder 1012, and outputs the calculated CTU position and the decoding time point information of each DU to the decoding time point calculation unit 1014.

The decoding time point calculation unit 1014 calculates the decoding time point of each DU from the decoding time point information of each DU output by the screen division unit 1013, and notifies the entropy decoder 1012 of the calculated decoding time point.

The screen division unit 1015 designates the number of rectangular regions and the position and size of each rectangular region on the basis of the region information output by the entropy decoder 1012, and divides the image into a plurality of rectangular regions. Then, the screen division unit 1015 outputs information on the plurality of rectangular regions and the reference constraint information to the reference block designation unit 1016.

The reference block designation unit 1016 designates the reference constraint for the coded block in each CTU on the basis of the positional relationship between the blocks in the coded image, and the information on the plurality of rectangular regions and the reference constraint information output by the screen division unit 1015, and generates a determination result that indicates the designated reference constraint.

The coded block represents a block to be decoded by source decoding, and the positional relationship between the blocks includes a positional relationship between the coded block and an adjacent block adjacent to the coded block. The determination result indicates whether referring to information on the adjacent block is permitted in a decoding process for the coded block.

The source decoder 1017 decodes the decoding target code output by the entropy decoder 1012 by source decoding in the order of decoding. At this time, the source decoder 1017 designates whether to refer to information on the adjacent block, in accordance with the determination result of the reference block designation unit 1016. Source decoding includes inverse quantization, inverse orthogonal transformation, addition of a restoration prediction error and a predicted value, and an in-loop filter.

The frame memory 1018 stores the decoded image constituted by the decoded pixel values of the CTUs generated by the source decoder 1017, and outputs the decoded pixel values to the source decoder 1017 when the source decoder 1017 decodes the succeeding coded CTU. The output decoded pixel values are used to generate the predicted value for the succeeding coded CTU. Then, the frame memory 1018 generates the decoded video by outputting a plurality of decoded images in the order of decoding.

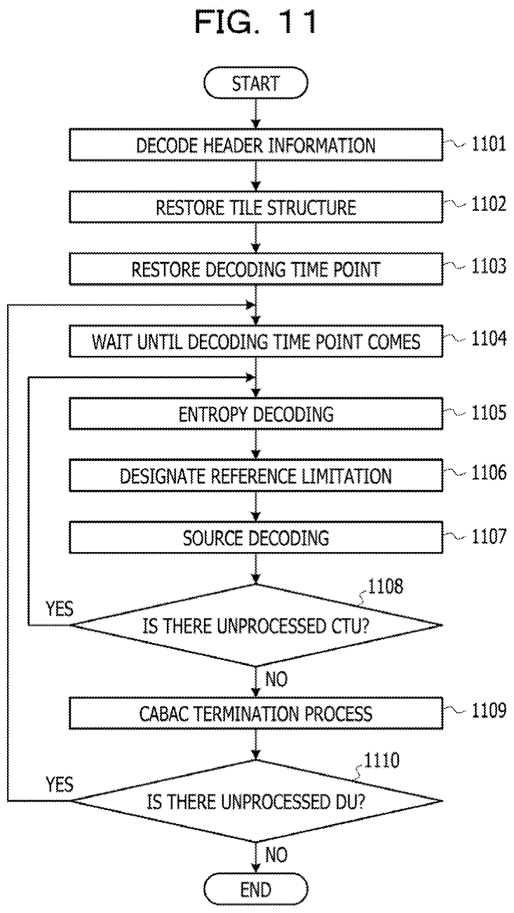

FIG. 11 is a flowchart illustrating an example of a video decoding process performed by the video decoding device 1001. The video decoding process in FIG. 11 is applied to each coded image contained in the bitstream. In this video decoding process, the tiles are used as the rectangular regions.

First, the video decoding device 1001 decodes the coded data of the header information of the coded image by entropy decoding (step 1101). Then, the video decoding device 1001 restores the tile structure of the coded image (step 1102), and restores the decoding time point of each DU (step 1103).

The video decoding device 1001 waits until the decoding time point of the DU to be processed next comes (step 1104). When the decoding time point of the DU comes, the video decoding device 1001 performs entropy decoding on CTUs in the DU in the order of the bitstream (step 1105). Then, the video decoding device 1001 designates the reference limitations for the coded blocks in the CTUs (step 1106).

Next, the video decoding device 1001 performs source decoding on the CTUs (step 1107), and checks whether an unprocessed CTU remains in the DU (step 1108). When an unprocessed CTU remains (step 1108, YES), the video decoding device 1001 repeats the processes in step 1105 and the subsequent steps. When no unprocessed CTU remains (step 1108, NO), the video decoding device 1001 performs the CABAC termination process (step 1109).

Next, the video decoding device 1001 checks whether an unprocessed DU remains in the coded image (step 1110). When an unprocessed DU remains (step 1110, YES), the video decoding device 1001 repeats the processes in step 1104 and the subsequent steps. When no unprocessed DU remains (step 1110, NO), the video decoding device 1001 ends the process.

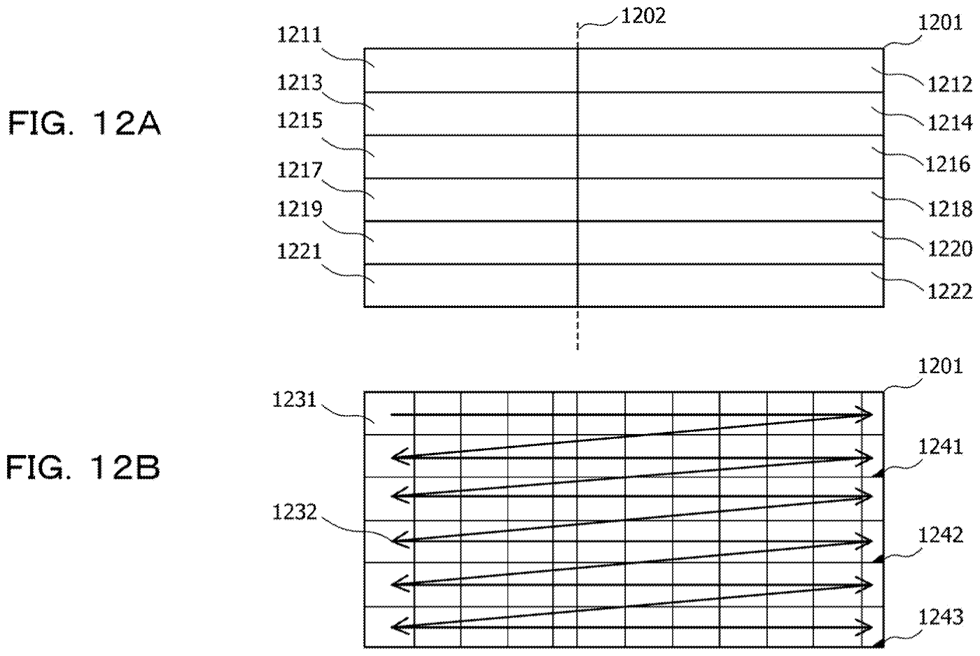

FIGS. 12A and 12B illustrates an example of second picture division when the tiles are used as the rectangular regions. FIG. 12A illustrates an example of tiles in a picture corresponding to the coding target image. Each CTU line in a picture 1201 is divided into two tiles, and the picture 1201 is divided into tiles 1211 to 1222. The boundary between the two tiles contained in each CTU line coincides with a virtual reference boundary 1202. The reference boundary 1202 extends in a perpendicular direction (vertical direction) in the picture 1201.

FIG. 12B illustrates an example of CTUs in the picture 1201. The picture 1201 is divided into a plurality of CUs 1231. In this example, the position of the reference boundary 1202 in the horizontal direction does not match a position at an integral multiple of the CTU width, and thus the shape of a CTU adjacent to the reference boundary 1202 on the left side is rectangular rather than square.

A processing order 1232 of the respective CTUs in the picture 1201 is the raster scan order in the picture 1201 independent of the shapes of the tiles 1211 to 1222.

CTU positions 1241 to 1243 indicate boundaries between DUs when the picture 1201 is divided into three DUs, and are set at positions immediately after the coding results for blocks in contact with a right end of the picture 1201. In this case, the entropy coder 519 performs entropy coding in accordance with the CTU positions 1241 to 1243. Accordingly, the CABAC termination process is performed at each of the CTU positions 1241 to 1243.

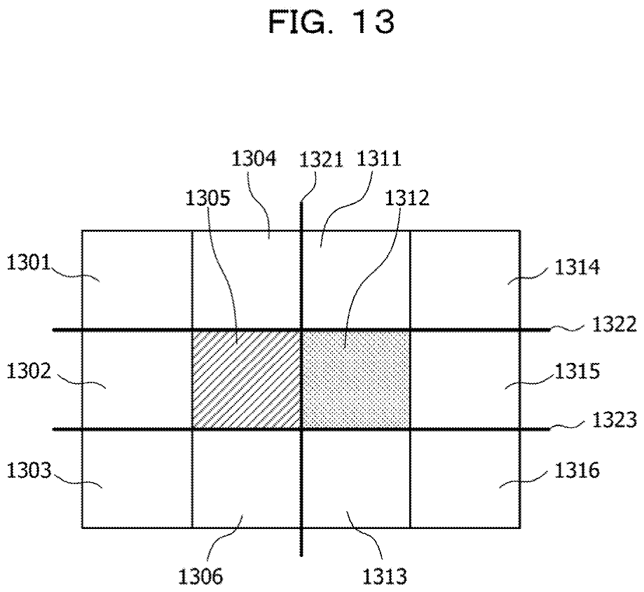

FIG. 13 illustrates an example of the reference constraint in the second picture division in FIGS. 12A and 12B. A boundary 1321 between tiles corresponds to the reference boundary 1202 in FIGS. 12A and 128, and boundaries 1322 and 1323 between the tiles correspond to the boundaries between the CTU lines. CTUs 1301 to 1306 are located on the left side of the boundary 1321, and CTUs 1311 to 1316 are located on the right side of the boundary 1321.

The screen division unit 512 generates the reference constraint information between CTUs on the basis of the moving direction of the reference boundary 1202. For example, when the reference boundary 1202 moves from the left to the right, referring to information on a block in a CTU located on the right side of the boundary 1321 from a block in a CTU located on the left side of the boundary 1321 is limited.

For example, when the CTU 1305 is to be processed, CUs in the CTU 1305 are allowed to refer to only information on CUs in the CTUs 1301 to 1306 located on the left side of the boundary 1321. Accordingly, it is prohibited to refer to information on CUs in the CTUs 1311 to 1316 located on the right side of the boundary 1321.

On the other hand, when the CTU 1312 is to be processed, CUs in the CTU 1312 are also allowed to refer to information on CUs in the CTUs 1301 to 1306 in addition to information on CUs in the CTUs 1311 to 1316.

In this manner, at the boundary 1321, a reference constraint when information on a block in the tile on the right side is referred to from a block in the tile on the left side, and a reference constraint when information on a block in the tile on the left side is referred to from a block in the tile on the right side are defined asymmetrically. These reference constraints do not apply to the boundaries 1322 and 1323.

Note that, when intra-prediction is performed, a reference constraints according to the processing order is further applied as in the HEVC standard. For example, in intra-prediction, it is prohibited for a CU in the CTU 1312 to refer to information on a CU in the CTU 1306.

The picture division in FIGS. 12A and 12B and the reference constraint in FIG. 13 are applied to the video decoding device 1001 similarly to the video coding device 501.

A bitstream when the picture division in FIGS. 12A and 128 is adopted is similar to the bitstream in FIG. 8. However, the operation is switched as follows depending on the value of BoundaryCntlIdc.

In the case of BoundaryCntIdc=0: referring to intra-prediction across tile boundaries is not permitted, but referring to pixels for the in-loop filter is allowed. This operation corresponds to a case where LoopFilterAcrossTilesEnabledFag of the HEVC standard has 1.

In the case of BoundaryCntIdc=1: referring to intra-prediction across tile boundaries is not permitted, and referring to pixels for the in-loop filter is not permitted as well. This operation corresponds to a case where LoopFilterAcrossTilesEnabledFag of the HEVC standard has 0.

In the case of BoundaryCntIdc=2: a CU as a target to be processed is not permitted to refer to information on a CU located on an opposite side of a tile boundary in the perpendicular direction adjacent to the target CU to the left. This operation is adopted when there is an intra-coded region on the left side of the virtual reference boundary.

In the case of BoundaryCntIdc=3: a CU as a target to be processed is not permitted to refer to information on a CU located on an opposite side of a tile boundary in the perpendicular direction adjacent to the target CU to the right. This operation is adopted when there is an intra-coded region on the right side of the virtual reference boundary.

Note that information can always be referred to between CUs contained in the same tile.

The configuration of the video coding device 501 in FIG. 5 is merely an example and some constituent elements may be omitted or modified depending on the use or conditions of the video coding device 501.

The configuration of the video decoding device 1001 in FIG. 10 is merely an example and some constituent elements may be omitted or modified depending on the use or conditions of the video decoding device 1001.

The flowcharts illustrated in FIGS. 9 and 11 are merely examples, and some processes may be omitted or modified depending on the configuration or conditions of the video coding device 501 or the video decoding device 1001.

The video coding device 501 in FIG. 5 and the video decoding device 1001 in FIG. 10 can be implemented as hardware circuits or can also be implemented using an information processing device (computer).

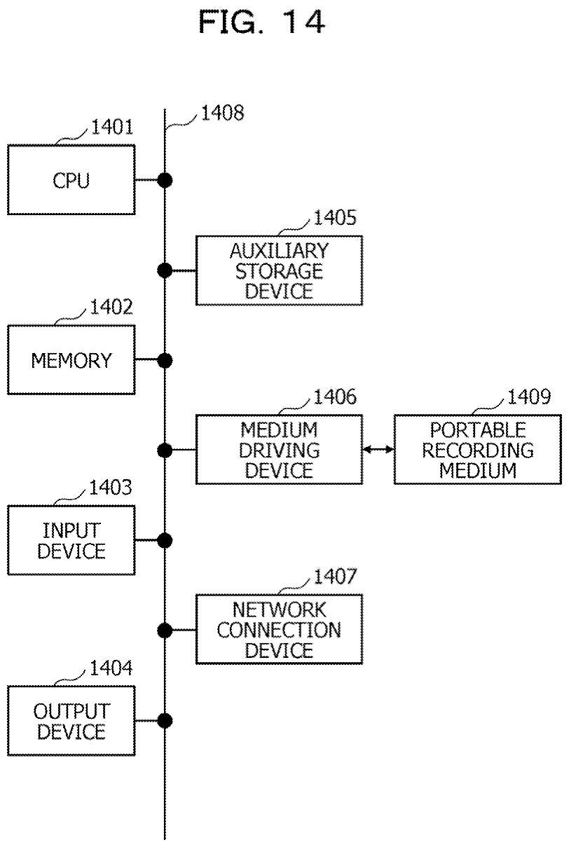

FIG. 14 illustrates a configuration example of an information processing device used as the video coding device 501 or the video decoding device 1001. The information processing device in FIG. 14 includes a central processing unit (CPU) 1401, a memory 1402, an input device 1403, an output device 1404, an auxiliary storage device 1405, a medium driving device 1406, and a network connection device 1407. These constituent elements are connected to one another by a bus 1408.

The memory 1402 is, for example, a semiconductor memory such as a read only memory (ROM), a random access memory (RAM), or a flash memory, and stores programs and data to be used for the process. The memory 1402 can be used as the frame memory 516 and the stream buffer 520 in FIG. 5. The memory 1402 can also be used as the stream buffer 1011 and the frame memory 1018 in FIG. 10.

The CPU 1401 (processor) operates as the coding control unit 511, the screen division unit 512, the coding order control unit 513, the reference block designation unit 514, and the source coder 515 in FIG. 5 by executing a program using the memory 1402, for example. The CPU 1401 also operates as the screen division unit 517, the decoding time point calculation unit 518, and the entropy coder 519 by executing a program using the memory 1402.

The CPU 1401 also operates as the entropy decoder 1012, the screen division unit 1013, and the decoding time point calculation unit 1014 in FIG. 10 by executing a program using the memory 1402. The CPU 1401 also operates as the screen division unit 1015, the reference block designation unit 1016, and the source decoder 1017 by executing a program using the memory 1402.

The input device 1403 is, for example, a keyboard, a pointing device, or the like, and is used for inputting instructions and information from a user or an operator. The output device 1404 is, for example, a display device, a printer, a speaker, or the like, and is used for making an inquiry to the user or the operator and outputting a processing result. The processing result may be a decoded video.

The auxiliary storage device 1405 is, for example, a magnetic disk device, an optical disk device, a magneto-optical disk device, a tape device, or the like. The auxiliary storage device 1405 may be a hard disk drive. The information processing device can save programs and data in the auxiliary storage device 1405 and load these programs and data into the memory 1402 to use.

The medium driving device 1406 drives a portable recording medium 1409 and accesses the recorded contents of the portable recording medium 1409. The portable recording medium 1409 is a memory device, a flexible disk, an optical disk, a magneto-optical disk, or the like. The portable recording medium 1409 may be a compact disk read only memory (CD-ROM), a digital versatile disk (DVD), or a universal serial bus (USB) memory. The user or the operator can save programs and data in this portable recording medium 1409 and load these programs and data into the memory 1402 to use.

As described above, a computer-readable recording medium in which the programs and data used for processes are saved includes a physical (non-transitory) recording medium such as the memory 1402, the auxiliary storage device 1405, and the portable recording medium 1409.

The network connection device 1407 is a communication interface circuit that is connected to a communication network such as a local area network (LAN) and a wide area network (WAN), and that performs data conversion pertaining to communication. The network connection device 1407 can transmit the bitstream to the video decoding device 1001 and can receive the bitstream from the video coding device 501. The information processing device can receive programs and data from an external device via the network connection device 1407 and load these programs and data into the memory 1402 to use.

Note that the information processing device does not need to include all the constituent elements in FIG. 14, and some constituent elements may be omitted depending on the use or the condition. For example, when an interface with the user or the operator is not needed, the input device 1403 and the output device 1404 may be omitted. Furthermore, when the information processing device does not access the portable recording medium 1409, the medium driving device 1406 may be omitted.

While the disclosed embodiments and the advantages thereof have been described in detail, those skilled in the art will be able to make various modifications, additions, and omissions without departing from the scope of the present embodiments as explicitly set forth in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A video coding device comprising:
a memory; and
a processor coupled to the memory and configured to:
divide a coding target image contained in a video into a plurality of regions to generate region information that indicates the plurality of regions;
generate reference constraint information that asymmetrically defines a reference constraint when information on a block in a second region is referred to from a block in a first region at one of boundaries between the first region and the second region among the plurality of regions, and a reference constraint when information on the block in the first region is referred to from the block in the second region at the one of boundaries;
generate a determination result that indicates whether to refer to information on an adjacent block adjacent to a coding target block, based on a positional relationship between the coding target block and the adjacent block, and the reference constraint information;
code the coding target block in accordance with the determination result; and
code the region information, the reference constraint information, and one of coding results for the coding target block.

2. The video coding device according to claim 1, wherein, in the coding results for a plurality of blocks contained in the coding target image, the processor codes the region information, the reference constraint information, and the one of the coding results for the coding target block in accordance with delimiter positions different from the boundaries between the plurality of regions.

3. The video coding device according to claim 2, wherein the processor generates position information that indicates the delimiter positions different from the boundaries between the plurality of regions, and decoding time point information that indicates a time point when decoding of one of the coding results contained between two of the delimiter positions is started, and codes the position information and the decoding time point information together with the region information, the reference constraint information, and the one of the coding results for the coding target block.

4. The video coding device according to claim 3, wherein the processor sets each of the delimiter positions different from the boundaries between the plurality of regions immediately after one of the coding results for a block in contact with a right end of the coding target image.

5. The video coding device according to claim 1, wherein the one of the boundaries between the first region and the second region is a boundary that extends in a perpendicular direction in the coding target image.

6. A video coding method executed by a video coding device,
the video coding method comprising:
dividing a coding target image contained in a video into a plurality of regions to generate region information that indicates the plurality of regions;
generating reference constraint information that asymmetrically defines a reference constraint when information on a block in a second region is referred to from a block in a first region at one of boundaries between the first region and the second region among the plurality of regions, and a reference constraint when information on the block in the first region is referred to from the block in the second region at the one of boundaries;
generating a determination result that indicates whether to refer to information on an adjacent block adjacent to a coding target block, based on a positional relationship between the coding target block and the adjacent block, and the reference constraint information;
coding the coding target block in accordance with the determination result; and
coding the region information, the reference constraint information, and one of coding results for the coding target block,
by the video coding device.

7. A video decoding device comprising:
a memory; and
a processor coupled to the memory and configured to:
decode a coded video to restore region information that indicates a plurality of regions in a coded image contained in the coded video, restores reference constraint information that asymmetrically defines a reference constraint when information on a block in a second region is referred to from a block in a first region at one of boundaries between the first region and the second region among the plurality of regions, and a reference constraint when information on the block in the first region is referred to from the block in the second region at the one of boundaries;
restore a decoding target code that indicates coded blocks in the coded image;
divides the coded image into the plurality of regions based on the region information;
generate a determination result that indicates whether to refer to information on an adjacent block adjacent to one of the coded blocks, based on a positional relationship between the one of the coded blocks and the adjacent block, and the reference constraint information; and
decode the decoding target code in accordance with the determination result.

8. The video decoding device according to claim 7, wherein, in a plurality of the coded blocks contained in the coded image, the processor decodes the coded video in accordance with delimiter positions different from the boundaries between the plurality of regions.
